(19) United States
(12) Patent Application Publication
(10) Pub. No.: US 2013/0238118 A1
(43) Pub. Date: Sep. 12, 2013

(54) fD

(71) Applicant: Alfred M. Haas, Oakhurst, NJ (US)

(72) Inventor: Alfred M. Haas, Oakhurst, NJ (US)

(21) Appl. No.: 13/753,566

(22) Filed: Jan. 30, 2013

Related U.S. Application Data
(60) Provisional application No. 61/592,489, filed on Jan. 30, 2012.

(51) Int. Cl. G07F 11/00

(52) U.S. Cl. CPC G07F 11/00
USPC 700/231; 426/580; 426/614; 426/615; 426/594; 426/597; 426/631; 423/580.1; 562/400; 530/300; 530/350; 554/1; 568/852; 552/502; 536/1.11; 536/123.13; 536/2; 536/114; 536/102; 536/123.1; 560/41; 548/211; 544/274; 568/700; 435/183

(57) ABSTRACT

The invention disclosed herein relates to methods and means for allocating, allotting, apportioning, dispensing, distributing, preparing, portioning, meting out and/or otherwise providing, controlling and/or regulating access to quantities of foods, beverages, and/or other substances. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS:

Pursuant to 35 USC §119(e) and as set forth in the Application Data Sheet, this utility application claims the benefit of priority from U.S. Provisional Patent Application No. 61/592,489 (“the '489 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '489 provisional and expressly incorporates by reference the disclosures contained therein in their entirety, including but not limited to all patents, patent applications, and publications which are incorporated by reference in the '489 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc. . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc. . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: smart and other scales, thermostats, e-readers (e.g. Kindle™ and Nook™), hearing aids, laptop and desktop computers, alarms, smart phones, PDAs, other commercially available electronic devices such as tablet PCs, netbooks, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc. . . .

Examples of commercial-off-the-shelf hardware, including but not limited to processing units, displays, microphones, communications modules, sensors, and speakers, may be found on the DigiKey website, www.digikey.com, the Allied Electronics website, www.alliedelec.com, and the website www.globalspec.com. Details pertaining to hardware identified on these sites may be found in their associated sensor and product data sheets and published specifications.

Examples of commercially available chemicals, reagents and scientific equipment may be found on the Fisher Scientific website, www.fishersci.com, and the Sigma-Aldrich website, www.sigmaaldrich.com. Details pertaining to these items may be found in their associated product descriptions, published specifications and material safety data sheets.

Examples of commercially available baking goods and supplies may be found on the King Arthur web site, www.kingarthurflour.com. Details pertaining to such goods and supplies may be found in their associated product descriptions. Examples of commercially available cosmetics may be found on the Mary Kay cosmetics website, www.marykay.com, and on the Maybelline website, www.maybelline.com. Details pertaining to these cosmetics may be found in their associated product descriptions and published data.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, methods and other aspects of some embodiments of the disclosed invention—including, but not limited to, foods, beverages and/or other substances, cooking, software and hardware such as sensors and transducers, circuits, transmitters, receivers, housings, wearable and other mobile devices, optics, programmable logic elements and chips, custom ASICs, electrical and mechanical switches, electrical and mechanical regulators, extruders, dispensing means, locking means, etc.: Lange's Handbook of Chemistry, Fifteenth Edition, edited by John R. Dean, published by McGraw-Hill, copyright 1999; Hawley's Condensed Chemical Dictionary, Thirteenth Edition, revised by Richard J. Lewis, Sr., published by John Wiley & Sons, copyright 1997; Food Chemistry, Second Edition, by H.-D. Belitz, W. Grosch, published by Springer-Verlag, copyright 1999; Organic Chemistry, Third Edition, by G. Marc Loudon, published by The Benjamin/Cummings Publishing Company, copyright 1995; Goodman and Gilman's The Pharmacological Basis of Therapeutics, Eighth Edition, edited by Alfred Goodman Gilman, Theodore W. Rall, Alan S. Nies, Palmer Taylor, published by Pergamon Press, copyright 1990; Biochemistry, by Christopher W. Mathews, K. E. van Holde, published by The Benjamin/Cummings Publishing Company, copyright 1990; Chemical Separations and Measurements: The Theory and Practice of Analytical Chemistry, Dennis G. Peters, John M. Hayes, Gary M. Hieftje, published by W. B. Saunders Company, copyright 1974; Physical Chemistry, Seventh Edition, by Robert A. Alberty, published by John Wiley & Sons, copyright 1987; The Cake Bible, by Rose Levy Beranbaum, published by William Morrow and Company, copyright 1988; The Cook's Bible, The Best of American Home Cooking, by Christopher Kimball, published by Little, Brown and Company, copyright 1996; Cookwise, the hows and whys of successful cooking, by Shirley O. Corriher, published by William Morrow and Company, copyright 1997; Cocktails, Style Recipes, edited by Clay Ide, published by Fireside a division of Simon and Schuster, copyright 2005; Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for allocating, allotting, apportioning, dispensing, distributing, preparing, portioning, meting out and/or otherwise providing, controlling and/or regulating access to quantities of foods, beverages, and/or other substances.

### BRIEF DESCRIPTION OF THE SEVERAL VIEWS OF THE DRAWINGS

FIGS. 1.A-1.B illustrate one specific example of some embodiments of the invention comprising a controlled container.

FIGS. 2.A-2.B illustrate a specific example of some embodiments of a controlled container comprising a refrigerator.

FIGS. 3.A-3.D illustrate a specific example of some embodiments of a controlled container comprising a spice dispenser.

FIGS. 4.A-4.C comprise illustrative examples of components of some embodiments of electromechanical dispensing means.

FIGS. 5.A-5.C depict a specific example of a dispensing mechanism according to some embodiments of the instant invention.

FIGS. 6.A-6.C illustrate specific examples of pill dispensers according to some embodiments of the invention.

FIG. 7 shows a specific example of an electromechanical dispenser according to some embodiments of the invention

FIG. 8 shows a specific example of a paper towel dispenser according to some embodiments of the invention.

FIG. 9 shows an example of a soap dispensing means according to some embodiments of the invention.

FIGS. 10.A-10.C illustrate specific examples of edible printing compositions, methods and means according to some embodiments of the invention.

### DETAILED DESCRIPTION OF THE INVENTION

The invention disclosed herein relates to methods and means for allocating, allotting, apportioning, dispensing, distributing, preparing, portioning, meting out and/or otherwise providing, controlling and/or regulating access to quantities of foods, beverages, and/or other substances.

Although it is not believed that drawings are necessary for the understanding of the subject matter sought to be patented, for illustrative purposes we have included several figures related to specific examples of embodiments of the disclosed invention.

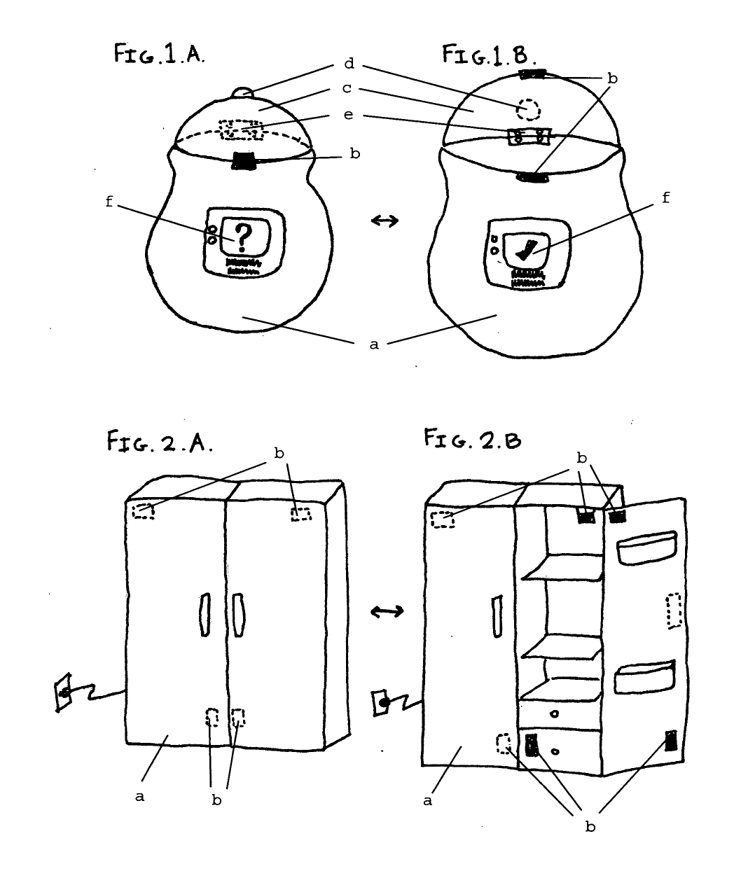

FIGS. 1.A-1.B show schematic illustrations of one specific example of an embodiment of the invention comprising a controlled container having a body, (a), lid, (c), with handle, (d), hinge (mistakenly omitted from the drawing in FIG. 1.B), (e), locking means, (b), and user interface, (f). In FIG. 1, the body of the controlled container comprises inner and outer surfaces and an enclosed region that is defined and bounded by the inner surface of the body and by a bottom surface of the hinged lid, with the bottom surface of the lid forming a top of the enclosed region. A controlled container, including but not limited to a dispenser, may comprise almost any material composition. In some embodiments, a controlled container and/or dispenser may comprise material that is be conformal, flexible, malleable, moveable, pliable, plastic, rubbery, and/or stretchable. Illustrative examples of materials that may comprise a housing include but are not limited to: glass, plastic, ceramic, silicone and/or rubber, stone, crystal, wood, metal and metal alloys (e.g. aluminum, steel, stainless steel, iron, copper, titanium, etc.), other polymers (e.g. ABS, polyethylene, etc.), and other composite materials (e.g. carbon fiber). In some embodiments, a controlled container and/or dispenser may be sealed, water proofed, water-resistant, air-tight, permeable, semi-permeable, and/or have openings. In some embodiments, the interior region of a controlled container and/or dispenser may be further compartmentalized, divided, or otherwise separated into different regions, each of which may be sealed, water proofed, water-resistant, air-tight, permeable, semi-permeable, and/or have openings.

In some embodiments of the instant invention, a container may comprise a conformal lining or coating—for example a recyclable and/or disposable plastic bag, or other coating (e.g. silicone rubber or other polymer layer) that may be layered onto (e.g. by spraying, deposition, pouring, “dunking”—i.e., submerging a container in polymer, painting, printing, etching, etc. . . . ) one or more surfaces of a container. In some embodiments, multiple linings may be layered and/or nested inside and/or onto a container, and may be peeled off or otherwise removed and recycled or disposed after one or more uses. In some embodiments, nested layers may be water resistant, permeable and/or water proof.

In some embodiments locking means may comprise some electromechanical means, for example comprising a solenoid. In some embodiments locking means may comprise electromagnetic means, for example an electromagnet. In some embodiments, locking means may comprise mechanical means, for example a pin, a latch, or a keyed or combination lock. In some embodiments, locking means may comprise some combination of mechanical, electromechanical and/or electromagnetic means.

The user interface of the specific example of an embodiment of a controlled container schematically represented by FIG. 1 comprises hardware and/or software for interacting with one or more individuals. In some embodiments, a user interface may comprise a processing unit and in some embodiments a user interface may comprise a communications module which may in some embodiments be integrated with a processing unit. In some embodiments a user interface may comprise a display, an input means, and one or more speakers. As one specific example, a user interface may comprise a keypad, a display, a speaker and a microphone, as well a processing unit. In such an example of an embodiment, a user interface might serve as a computer gatekeeper, controlling access to the enclosed region when a user, e.g. enters a code, answers a question correctly, or solves a puzzle. In some embodiments of the invention, a processing unit may comprise a microcontroller. In some embodiments, a processing unit may comprise one or more of a display driver, speaker drivers, input channels, power conditioning circuits, memory, and power supply regulation circuitry. In some embodiments, a processing unit may comprise hardware and/or software for performing other functions including but not limited to processing and transmitting data, processing and transmitting power, controlling and/or operating other hardware and/or software, storing and retrieving data, receiving and decoding voice or other commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software. In some embodiments of the invention, a processing unit may comprise a communications module —for example, a transceiver with antenna for communicating with other circuits, components, devices, systems, networks and individuals using electromagnetic (“EM”) waves.

In some embodiments, a communications module may be used to transmit and receive data including for example but not limited to a detected event, a sensed signal, digital GPS coordinates, sound samples, images, the identity of a food or beverage (for example, receiving such information from an input device such as a bar code reader, or scanner such as a cell phone bar code reader), nutritional information pertaining to a food and/or beverage, compositional information concerning a substance and/or thing, firmware and software updates, as well as other data (e.g., the time and date, weather conditions, etc. . . . ). In some embodiments, a communications module may comprise an antenna and/or coil for transmitting and/or receiving EM signals. In some embodiments a communications module may be integrated with the processing unit and/or comprise a separate component that may in some embodiments communicate with the processing unit. In some embodiments, a communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc. . . . ). In some embodiments a communications module may also communicate via wires which are not illustrated, for example using one of a variety of USB cables. In addition, in some embodiments a communications module may include speakers and/or microphones and associated circuits for receiving and decoding voice commands and for generating sounds, including but not limited to speech. In some embodiments a communications module may be integrated with the power supply—for example by capturing, harvesting and/or storing ambient or transmitted energy from an EM signal. In some embodiments, rechargeable batteries may be charged using the energy harvested from EM signals. In some embodiments, a communications module may comprise a transmission means capable of producing vibration and/or low frequency compression waves, for example vibrating motors. In some embodiments, a communications module may comprise a transmission means comprising one or more lights, including but not limited to arrays of lights such as an LCD or LED display. For example, some embodiments comprise OLED (organic light emitting diode) displays like those found in modern cell phones and tablet PCs. However, as used in the context of this disclosure, displays are not intended to be limited to a single or even to existing technology —additional examples of displays comprise, but are not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks.

In some embodiments, a power supply may comprise batteries. Additional illustrative examples of a power supply include, but are not limited to, a battery holder, rechargeable batteries, solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal and/or electromechanical generator (think MEMS/NEMS generators), and any other suitable source of power.

In some embodiments, one or more weight sensing means may be embedded in an enclosed region of a controlled container, along with circuits for ascertaining and/or computing data concerning measured substances. In some embodiments, pressure and force sensors may be used to weigh or mass foods, beverages, and other substances, or to measure partial gas pressures from foods, beverages and other substances, and this data may be correlated with quantity. In some embodiments, chemical sensors may be used to ascertain quantities of ingredients, elements or components of foods, beverages and other substances, and this data may be correlated with quantity. For example, embedded alcohol sensors like those used in breathalyzer tests can be used to identify the quantity of alcohol in, e.g. a portion of beer poured into a mug, and thereby compute the quantity of beer in the mug.

FIGS. 2.A-2.B illustrate a specific example of an embodiment of a controlled container comprising a refrigerator, (a), having locking means, (b). In this specific example, the locking means comprises one example of electromechanical latches—when a specific electrical signal is applied, a solenoid switch locks one or more pairs of the latches together; when power is removed and/or another or no signal is applied, the latches are unlocked. In some embodiments, a controlled container comprising a refrigerator may further comprise means for locking one or more of its compartments, including for example but not limited to the freezer, a drawer, a crisper bin, a butter holder, or an egg holder. In some embodiments, a refrigerator or other appliance or enclosure may comprise more than one controlled container.

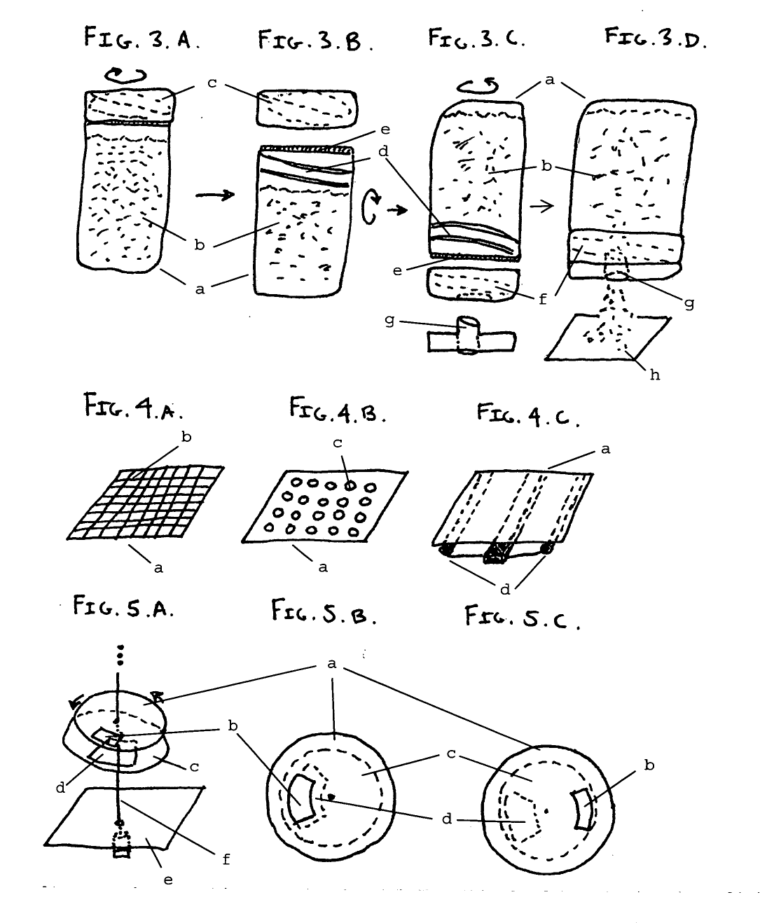

FIGS. 3.A-3.D illustrate a specific example of an embodiment of a controlled container comprising a spice dispenser. FIG. 3.A represents a container, (a), of dried spice, (b), having threaded cap, (c), which is being unscrewed as indicated by the arrow. FIG. 3.B illustrates the same container, (a), of dried spice, (b), with threaded cap, (c), removed and exposing container threads, (d), and lid, (e), and shows the container being turned upside down as indicated by the arrow. FIG. 3.C shows the container, (a), being screwed into socket, (f), having an aperture, and further shows movable, sharp inverted spigot, (g), being removably mated with the aperture in socket, (f), to puncture lid, (e), and dispense dried spice, (b), onto surface, (h), as shown in FIG. 3.D. In some embodiments, a dispenser may comprise means for opening a container, including for example but not limited to a can opening means, a box cutting means, and/or a puncturing means. In some embodiments, dispensing means may comprise one or more fixed apertures; in some embodiments, dispensing means may comprise one or more adjustable, closable, and/or sealable apertures. In the context of some embodiments of the instant invention, apertures are defined according to their broadest ordinary meaning and to specifically include dies, nozzles, sprayers, piping and other tips, slots, grooves, gratings, sieves, holes, and any other openings through which foods, beverages and/or substances may pass. In some embodiments, dispensing means may dispense spices and/or other ingredients through an aperture via gravitational force. In some embodiments, a dispensing means may employ suction and/or vacuum; in some embodiments, a dispensing means may employ pressure or generated force to convey and/or dispense foods, beverages and/or substances. In some embodiments, dispensing means may be controlled by hardware and/or software. In some embodiments, dispensing means may be controlled by one or more entities. In some embodiments dispensing means may be controlled by some combination of hardware, software and/or one or more entities.

FIGS. 4.A-4.C comprise illustrative examples of components of some embodiments of dispensing means. FIG. 4.A shows a surface, (a), comprising sieve means, (b), which surface may be movable, shakable, and/or vibrating. FIG. 4.B shows a surface, (a), comprising sharp edged raised apertures, (c), for grating foods and/or substances. FIG. 4.C shows a surface, (a), with motorized means, (d), for tilting the surface like a see-saw with respect to a fulcrum. In this specific figure, the surface may be carefully balanced on the fulcrum and moveable (e.g. by a servo or stepper motor) cams may be positioned to support one or more regions of the surface; depending on the position of one or more of the cams, the surface tilt accordingly.

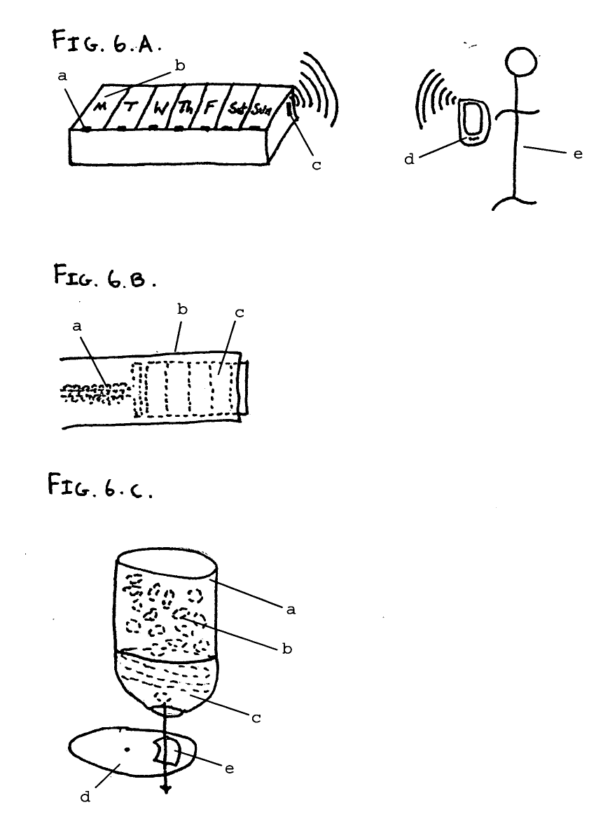

FIGS. 5.A-5.C depict a specific example of a dispensing means according to some embodiments of the instant invention. FIG. 5.A shows a pair of surfaces, (a) and (c), having respective apertures, (b) and (d), with surface (a) affixed to axle, (f), and surface (c) having a hole through which axle, (f), is disposed and may rotate freely, and surface, (e), on which axle, (f), rests and may rotate freely. FIG. 5.B shows a top down view of the two surfaces when their apertures are aligned. FIG. 5.C shows a top down view of the two surfaces when their apertures are not aligned. In these figures, means for moving one surface with respect to another are not explicitly shown, but may in some embodiments comprise motors, gears, pulleys, switches, latches, springs, and/or other mechanical and/or electromechanical or electromagnetic means. In some embodiments, surfaces (a) and (c) may be substantially planar and/or angled, curved, sloped or otherwise shaped, for example as a funnel.

FIGS. 6.A-6.C illustrate specific examples of some embodiments of dispensing means. FIG. 6.A shows a controlled container comprising a pill dispenser that is sectioned into seven compartments, (b), corresponding with the seven days of the week. In some compartmentalized and/or sectioned embodiments of the invention, each compartment or section may comprise a controlled container and/or each may comprise locking means, (a). FIG. 6.A further schematically illustrates examples of embodiments of some methods of the invention in which a pharmacist, (e), uses a tablet computer, (d), to download a prescribed medication dosage regimen to a pill dispenser. In this specific example the locking means are controlled—i.e. locked and unlocked—by a system comprising hardware and software that received and decoded the pharmacist's transmission and controls access to the pills accordingly. FIG. 6.B illustrates a specific embodiment of a dispenser employing a threaded screw, (a), inside threaded cylindrical body, (b), to turn and dispense heartburn tablets, (c), from an open end of the cylindrical body. FIG. 6.C shows a specific example of a dispenser, akin to a gumball machine, comprising pill bottle, (a), pills, (b), shaped funnel, (c), and rotatable dispensing surface, (d), having aperture, (e). In this specific example, when the opening in the funnel and the dispensing surface aperture are aligned, one or more pills may be dispensed, depending on the size and shape of the aperture in the dispensing surface, the opening in the funnel and the duration of their alignment. It should be noted that medication, vitamins, drugs (over-the-counter and prescription) as well as other substances may be dispensed in various other forms according to various embodiments of the invention. As one example, some medicines and vitamins comprise liquids and may be dispensed using, e.g., actuated (e.g. via solenoids) valves, and/or peristaltic or other pumps. As another specific example, some drugs may be powdered and/or particulate and may be dispensed by other means, e.g. by shaking, blowing, by sifting the powder through an aperture. As yet another example, a solid unit of a drug might be dispensed by, e.g., cutting, shaving, or abrading one or more portions of the unit.

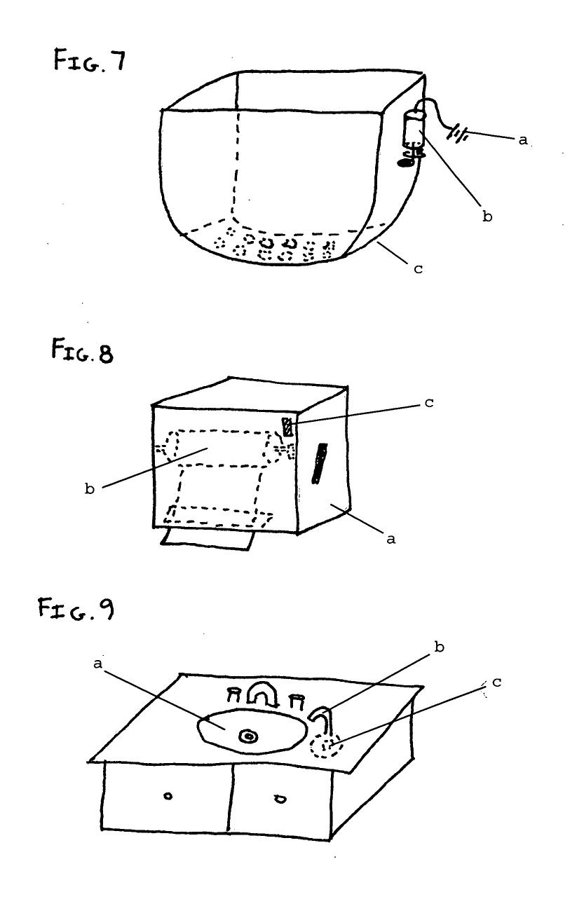

FIG. 7 shows an example of an embodiment—a dispenser, (c), having a vibrating motor, (b), and power supply, (a). In this specific example, operating the vibrating motor causes the dispenser to vibrate and this causes foods, beverages and/or substances, for example flour or powdered sugar, to be dispensed through apertures in a bottom surface of the dispenser.

FIG. 8 shows an example of an embodiment—a paper towel dispenser, (a), comprising a paper towel roll, (b), and sensing means, (c), according to an embodiment of the invention. In this specific example, sensing means, (c), comprises an optical sensor that counts rotations of a towel dispensing reel by detecting a marker affixed to an axle of the wheel. In some embodiments, an optical sensor may be disposed with a sensing region on one surface of an enclosed region of a dispenser and a light source (e.g. an LED) may on an opposite surface of the enclosed region, for example, with the paper towels being dispensed through the sensing path between the light and light sensor, or positioned sot that a full roll of paper towels would substantially occlude the sensor but would block proportionally less light as the roll was dispensed. In some embodiments the quantity of an item such as paper towels may be detected by weight and/or pressure sensing means; in some embodiments the quantity of an item such as paper towels may be detected using magnetic means; in some embodiments the quantity of an item may be detected using a counter to assess the quantity of an item dispensed. In some embodiments, other sensing means may be used to detect the quantity of an item.

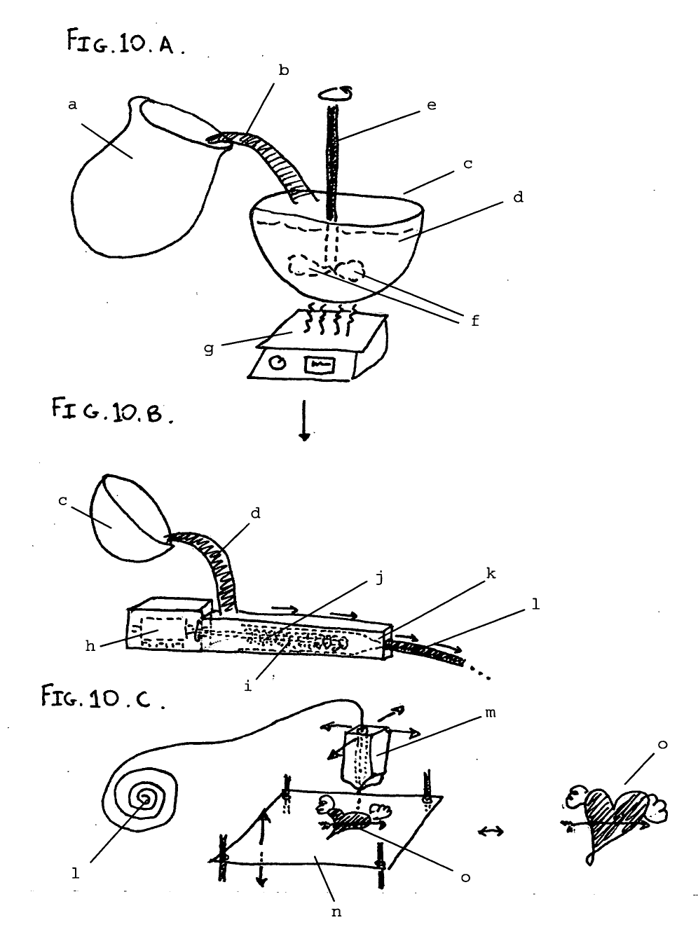

FIG. 9 shows an example of a soap dispensing means according to an embodiment of the invention. In this specific example, bathroom sink, (a), has soap dispensing means, (b), comprising a pump that dispenses liquid soap from a reservoir having sensing means, (c), for detecting and logging the amount of soap in the reservoir and when soap is dispensed.

FIGS. 10.A-10.C illustrate some examples of embodiments pertaining to edible printing. In FIG. 10.A, an ingredient, (b), is poured from bag, (a), into container, (c), where it is mixed by blades, (f), attached to shaft, (e), and in some embodiments combined with one or more other ingredients to form compound and/or mixture, (d), while in some embodiments being heated by heat source, (g). FIG. 10.B shows the contents of mixture and/or compound, (d), being poured from container, (c), into a forming chamber, (j), of an extrusion means having motor, (h), which drives screw means (which may comprise one or more screws), (i), to extrude edible filament, (l), through aperture, (k). In some embodiments, extrusion means may be manually operated. In some embodiments, ingredients may be combined, mixed, and/or heated in a region of a forming chamber. In some embodiments, an extruder may comprise additional components, for example a cooling means, and/or a filament collection apparatus. FIG. 10.C illustrates a cartoon of 3D printing using edible filament, (l), comprising feeding the edible filament through print head, (m), to print edible 3D object, (o), onto movable surface, (n).

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for allocating, allotting, apportioning, dispensing, distributing, preparing, portioning, meting out and/or otherwise providing, controlling and/or regulating access to quantities of foods, beverages, and/or other substances.

2. The means of claim 1 wherein the hardware comprises one or more of a cell phone, a tablet computer, a worn device comprising a microprocessor, and a personal digital assistant.

3. A method for allocating, allotting, apportioning, dispensing, distributing, preparing, portioning, meting out and/or otherwise providing, controlling and/or regulating access to quantities of foods, beverages, and/or other substances.

4. The method of claim 3 wherein one or more steps of the method involves the use of hardware comprising one or more of a cell phone, a tablet computer, a worn device comprising a microprocessor, and a personal digital assistant.

5. An edible composition suitable for printing comprising one or more of the following: (a) water; (b) amino acids; (c) peptides, e.g. comprising lysine; (d) proteins; (e) enzymes; (f) vitamins; (g) minerals; (h) lipids, e.g. comprising fatty acids, glycerols, sterols, and waxes; (i) carbohydrates and/or sugars, e.g. comprising mono-, oligo- and polysaccharides such as glucose, sucrose, dextrose, fructose, lactose, carrageenan, pectin, guar gum, and starch; (j) sugar substitutes, e.g. aspartame, saccharine, sorbitol and/or xylitol; (k) milk and milk products; (l) eggs; (m) fruits and/or vegetables; (n) alcohols; (o) caffeine; (p) coffee; (q) tea; and (r) cocoa and/or cacao.
